(19) United States
(12) Patent Application Publication
(10) Pub. No.: US 2012/0142402 A1
(43) Pub. Date: Jun. 7, 2012

(54) SHIELD AND MOBILE PHONE ENCLOSURE HAVING SAME

(75) Inventor: CHUNG-PEI WANG, New Taipei (TW)

(73) Assignee: HON HAI PRECISION INDUSTRY CO., LTD., New Taipei (TW)

(21) Appl. No.: 13/006,437

(22) Filed: Jan. 14, 2011

(30) Foreign Application Priority Data
Dec. 6, 2010 (TW) 99142477

(51) Int. Cl. H04W 88/02

(52) U.S. Cl. 455/575.8

(57) ABSTRACT

A shield includes a metallic substrate and a composite coating. The composite coating includes a thin film positioned on the metallic substrate and an anti-fingerprint paint coating positioned on the thin film. The thin film and the anti-fingerprint paint coating are light-pervious and insulating material. The anti-fingerprint paint coating is configured for eliminating thin layer chromatography of the thin film caused by thin-film interference.

### BACKGROUND

1. Technical Field

The disclosure generally relates to shielding, and particularly to a shield with a composite coating, and a mobile phone enclosure using the shield.

2. Description of Related Art

Electronic components of a portable device, such as a mobile phone, tend to interfere with each other as they generate electromagnetic signals, causing electromagnetic interference (EMI) in the mobile phone. Metallic enclosures are generally provided in the portable mobile phone to shield such EMI radiation.

However, contact with the metallic enclosure during use can create a connection which may negatively affect performance of the device.

Therefore, what is needed, is a shield and a mobile phone enclosure using the shield, which can overcome the described limitations.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is sectional view of a shield in accordance with a first embodiment.

FIG. 2 is sectional view of a shield in accordance with a second embodiment.

FIG. 3 is an isometric view of a mobile phone using the shield of FIG. 1 or FIG. 2.

### DETAILED DESCRIPTION

Embodiments of the shield will now be described in detail below and with reference to the drawings.

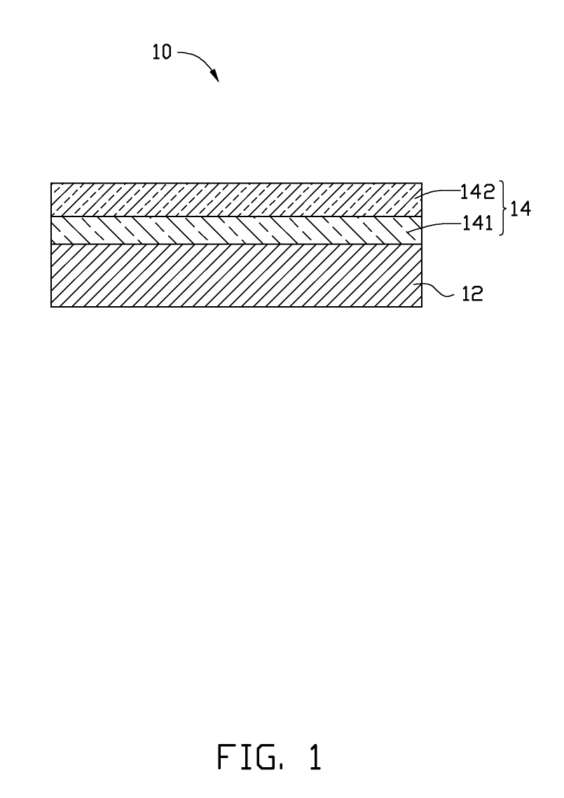

Referring to FIG. 1, a shield 10 in accordance with a first embodiment is shown. The shield 10 includes a metallic substrate 12 and a composite coating 14.

In this embodiment, the metallic substrate 12 can be essentially pure metal, such as Ni, Cu, Cr, Co, Ag or Au. In alternative embodiment, the metallic substrate 12 can be stainless steel or alloy, such as aluminum, magnesium alloy or zinc alloy.

The composite coating 14 includes a light-pervious thin film 141 and an anti-fingerprint (AFP) paint coating 142 formed on the thin film 141. The thin film 141 and the AFP coating 142 are both light-pervious and insulating material. The thin film 141 can be titanium dioxide (TiO₂), tantalum oxide (Ta₂O₅), niobium oxide (Nb₂O₅), aluminium oxide (Al₂O₃), silicon dioxide (SiO₂) or zirconium dioxide (ZrO₂). In this embodiment, the thin film 141 is SiO₂. The AFP coating 142 is polymer material. In addition, the thin film 141 can be formed on the metallic substrate 12 by vacuum evaporation, sputtering, or ion plating. The AFP coating 142 can be further formed on the thin film 141 by spraying.

The AFP coating 142 is configured for eliminating thin layer chromatography of the thin film 141 caused by thin-film interference, such that the original color of the metallic substrate 12 remains when the shield 10 is seen from a side of the composite coating 14 away from the metallic substrate 12. Overall, the elimination of the thin layer chromatography is achieved by arrangement of a thickness of the thin film 141 to match a thickness of the AFP coating 142, using thin-film interference theory.

For illustrating nature and operation of the shield 10, “L” denotes brightness of the color of an object, and “a” denotes red-green color of the object, while “b” denotes yellow-blue color of the object. A first exemplary value (L1, a1, b1) denotes a color value of the metallic substrate 12, and a second exemplary value (L2, a2, b2) denotes a color value of the entire shield 10. When the thickness of the thin film 141 matches the thickness of the AFP coating 142, the first value (L1, a1, b1) is substantially equal to the second value (L2, a2, b2). Accordingly, the color of the entire shield 20, as seen from a side of the composite coating 14 away from the metallic substrate 12 is substantially similar to or the same as the color of the metallic substrate 12, as seen directly from a side thereof without the composite coating 14 formed thereon. In this embodiment, the thickness of the thin film 141 is in a range from about 1700 nm to about 1900 nm, and the thickness of the AFP coating 142 is in a range from about 1000 nm to about 1500 nm. In one typical example, the thickness of the thin film 141 is about 1900 nm, and the thickness of the AFP coating 142 is about 1500 nm.

In this embodiment, the AFP coating 142 is an anti-fingerprint (AFP) paint coating with nanostructure/porous structure. That is, the AFP coating 142 defines a number of pores therein, such that the AFP coating 142 eliminates thin layer chromatography of the thin film 141 caused by thin-film interference efficiently.

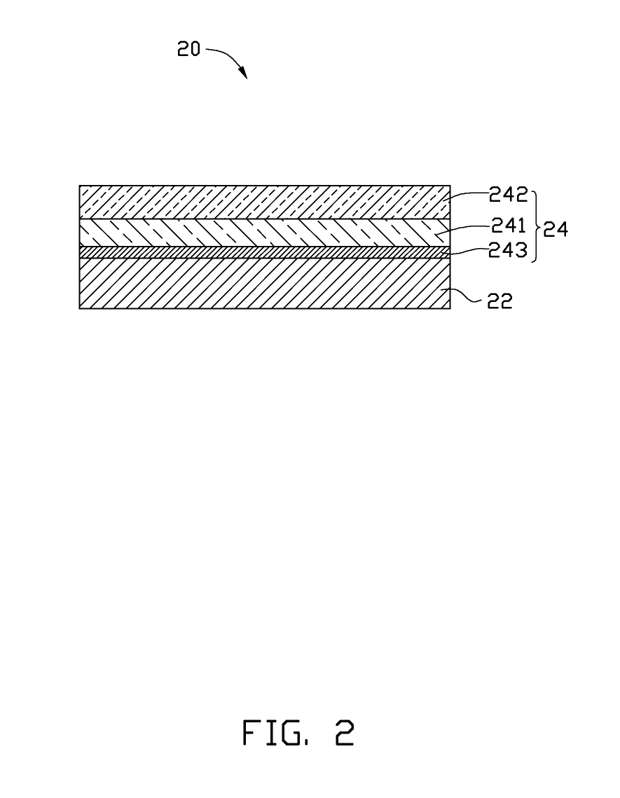

FIG. 2 illustrates a shield 20 according to a second embodiment, differing from shield 10 of the first embodiment only in that a metallic thin film 243 is further included in the composite coating 24. In this embodiment, the metallic thin film 243 is arranged between the metallic substrate 22 and the thin film 241, and the metallic thin film 243 is essentially metallic material, such as Al. In alternative embodiments, the metallic thin film 243 can be other metallic material, such as Ag, Ti, or W (tungsten).

The AFP coating 242 of the second embodiment is similar to the AFP coating 142 of the second embodiment in principle, and is configured for eliminating thin layer chromatography of the thin film 241 caused by thin-film interference. In this embodiment, the elimination of the thin layer chromatography is achieved by arrangement of a thickness of the thin film 241 to match a thickness of the AFP coating 242, as well as a thickness of the metallic thin film 243, using thin-film interference theory.

In this embodiment, for illustrating nature and operation of the shield 20, a third exemplary value (L3, a3, b3) denotes a color value of the metallic substrate 22, and a fourth exemplary value (L4, a4, b4) denotes a color value of the entire shield 20. When the thickness of the thin film 241 matches the thickness of the coating 242, as well as the thickness of the metallic thin film 243, the third value (L3, a3, b3) is substantially equal to the fourth value (L4, a4, b4). Accordingly, the color of the entire shield 20, as seen from a side of the composite coating 24 away from the metallic substrate 22 is substantially similar or same to the color of the metallic substrate 22, as seen directly from a side thereof without the composite coating 24 formed thereon. In this embodiment, the thickness of the metallic thin film 243 exceeds 0 and is less than 5 nm. The thickness of the thin film 241 is in a range from about 1700 nm to about 1900 nm. The thickness of the AFP coating 242 is in a range from about 1000 nm to about 1500 nm. In addition, the metallic thin film 243 can be formed on the metallic substrate 22 by vacuum evaporation, sputtering, or ion plating. The thin film 241 can be further formed on the metallic thin film 243 also by vacuum evaporation, sputtering, or ion plating. The AFP coating 242 can be further formed on the thin film 241 by spraying.

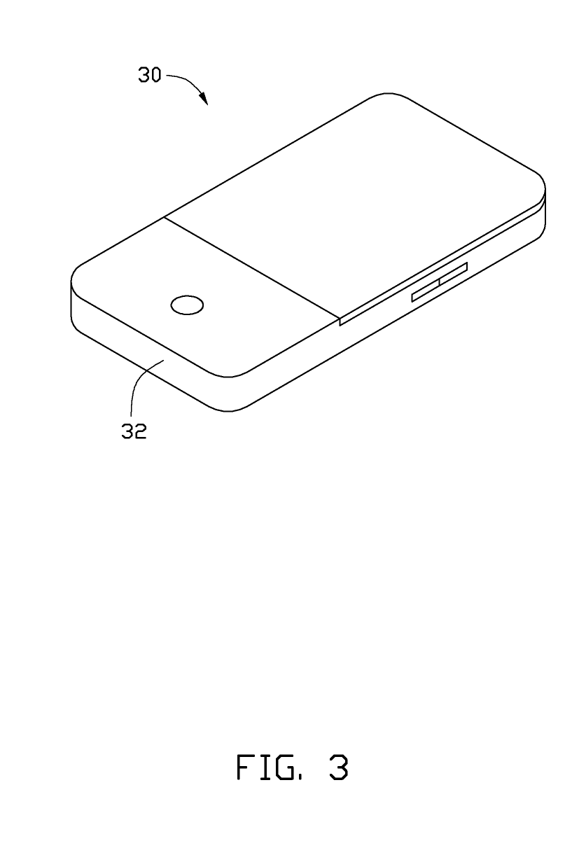

Referring to FIG. 3, the disclosure further relates to a mobile phone 30 using the shield 10 from the first embodiment. The mobile phone 30 includes an enclosure 32. The shield 10 from the first embodiment is applied on the enclosure 32. In this embodiment, the metallic substrate 12 of the shield 10 is formed on an external surface of the enclosure 32. The AFP coating 142 of the composite coating 14 is exposed to an exterior of the mobile phone 30.

In use, in one aspect, the shield 10 includes a metallic substrate 12 efficiently shielding EMI radiation. In another, the thin films 141 and the AFP coating 142 are insulating material, preventing unwanted electrical connection during operation of the mobile phone 30. Reliable performance of the mobile phone 30 is maintained. Furthermore, as the AFP coating 142 can eliminate thin layer chromatography of the thin film 141 caused by thin-film interference, the original color of the metallic substrate 12 remains when the mobile phone 30 is seen from a side of the composite coating 14 away from the metallic substrate 12.

In alternative embodiments, the mobile phone 30 with the shield 20 from the second embodiment applied on the enclosure 32 can also be considered within the scope of the disclosure.

It is understood that the described embodiments are intended to illustrate rather than limit the disclosure. Variations may be made to the embodiment without departing from the spirit of the disclosure. Accordingly, it is appropriate that the appended claims be construed broadly and in a manner consistent with the scope of the disclosure.

What is claimed is:

1. A shield comprising:
a metallic substrate; and
a composite coating comprising a thin film positioned on the metallic substrate and an anti-fingerprint paint coating positioned on the thin film, the thin film and the anti-fingerprint paint coating being light-pervious and insulating material, and the anti-fingerprint paint coating being configured for eliminating thin layer chromatography of the thin film caused by thin-film interference.

2. The shield of claim 1, wherein the thin film is comprised of material selected from the group consisting of TiO₂, Ta₂O₅, Nb₂O₅, Al₂O₃, SiO₂, and ZrO₂.

3. The shield of claim 2, wherein the thin film is comprised of SiO₂.

4. The shield of claim 1, wherein the anti-fingerprint paint coating is polymer material with nanostructure.

5. The shield of claim 1, wherein a thickness of the thin film is in a range from about 1700 nm to about 1900 nm.

6. The shield of claim 1, wherein a thickness of the anti-fingerprint paint coating is in a range from about 1000 nm to about 1500 nm.

7. The shield of claim 1, further comprising a metallic thin film arranged between the metallic substrate and the thin film.

8. The shield of claim 7, wherein the metallic thin film is comprised of material selected from the group consisting of Al, Ag, Ti, and W.

9. The shield of claim 7, wherein a thickness of the metallic thin film exceeds zero and less than 5 nm.

10. A mobile phone enclosure comprising a shield, the shield comprising:
a metallic substrate positioned on a surface of the enclosure, and
a composite coating comprising a thin film positioned on the metallic substrate and an anti-fingerprint paint coating positioned on the thin film and exposed to an exterior of the enclosure, the thin film and the anti-fingerprint paint coating being light-pervious and insulating material, and the anti-fingerprint paint coating being configured for eliminating thin layer chromatography of the thin film caused by thin-film interference.
